(19) United States
(12) Patent Application Publication
(10) Pub. No.: US 2006/0089984 A1
(43) Pub. Date: Apr. 27, 2006

(54) Process and implementation for autonomous probe enablement

(75) Inventors: Bryan Christopher Chagoly, Austin, TX (US); Xiaoping Chen, Austin, TX (US); Andrew Jason Lavery, Austin, TX (US); Kirk Malcolm Sexton, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/971,473

(22) Filed: Oct. 22, 2004

(51) Int. Cl. G06F 15/173

(52) U.S. Cl. 709/224

(57) ABSTRACT

A monitoring program for online transactions can define an ‘enable module’ that requires minimal overhead. When the monitoring program is triggered, the enable module is loaded without a context to determine if the probe is enabled, with the loading of any context deferred until enablement is determined. When the full probe is not needed, the associated overhead of loading a context is avoided.

### BACKGROUND OF THE INVENTION

1. Technical Field

This application relates generally to management of computer systems. More specifically, this application relates to allowing a monitoring process to make a determination whether or not it needs to execute, with the determination being made prior to execution of most of the overhead associated with the monitoring process.

2. Description of Related Art

In large computer system, such as those providing online information and services to clients, it is vital to be able to monitor transactions through a complex system, which can contain multiple computers, connections, and software programs. Such monitoring can be used to detect which specific areas are causing problems or slowdowns and to ensure that a contracted level of service is provided. However, the monitoring programs themselves can potentially use large amounts of overhead, so that it is necessary to minimize this overhead whenever possible.

Java is an object-oriented programming language that is platform independent, so that Java programs can run on virtually every system. A Java Virtual Machine (JVM) resides on a computer system and compiles Java programs from a platform-independent form to a machine-specific form for the machine on which it is installed. The JVM has the ability to interface with a monitoring agent such that when a Java class is compiled by the JVM, the monitoring agent can inject special byte-codes in the in-memory application. These byte-codes include runtime hooks that contain the logic to manage the execution of components of the monitoring programs called probes. When a hook is triggered, it gets the list of probes currently enabled for its location from a registry belonging to the monitoring agent and executes the probes. It is neither necessary nor generally desirable to monitor each and every transaction that passes through the system. Instead, mechanisms are provided to select a percentage of the transactions, such as 5%, 10%, or 20%. However, the information to determine whether or not to execute a probe is not available until a probe has been started. If there is a large amount of information that must be passed to the probe or when the probe is executed many times, a large amount of overhead is incurred. It would be desirable to provide a method by which the probe could determine whether it is needed or not, prior to the overhead associated with running the probe.

### SUMMARY OF THE INVENTION

A probe or monitoring program can use an ‘enable module’ that minimizes the overhead for a probe. After the hook or inserted byte code is invoked, the enable module of the probe determines if the full probe is needed. When the full probe is not needed, the overhead associated with execution of the entire probe, e.g., retrieving the context for the probe, is avoided so that only a small amount of overhead is incurred.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a network on which an embodiment of the invention can be run.

FIG. 2 depicts a server that can use an embodiment of the invention.

FIG. 3 depicts the relationship between the Java Virtual Machine (JVM), the monitoring agent, and a transaction running on the system.

FIG. 4 depicts a flowchart for the actions performed when a monitored transaction is invoked, according to an embodiment of the invention.

FIGS. 5A and 5B depicts the difference between running a probe according to the prior art and running a probe according to an embodiment of the present invention.

### DETAILED DESCRIPTION OF THE PREFERRED EMBODIMENT

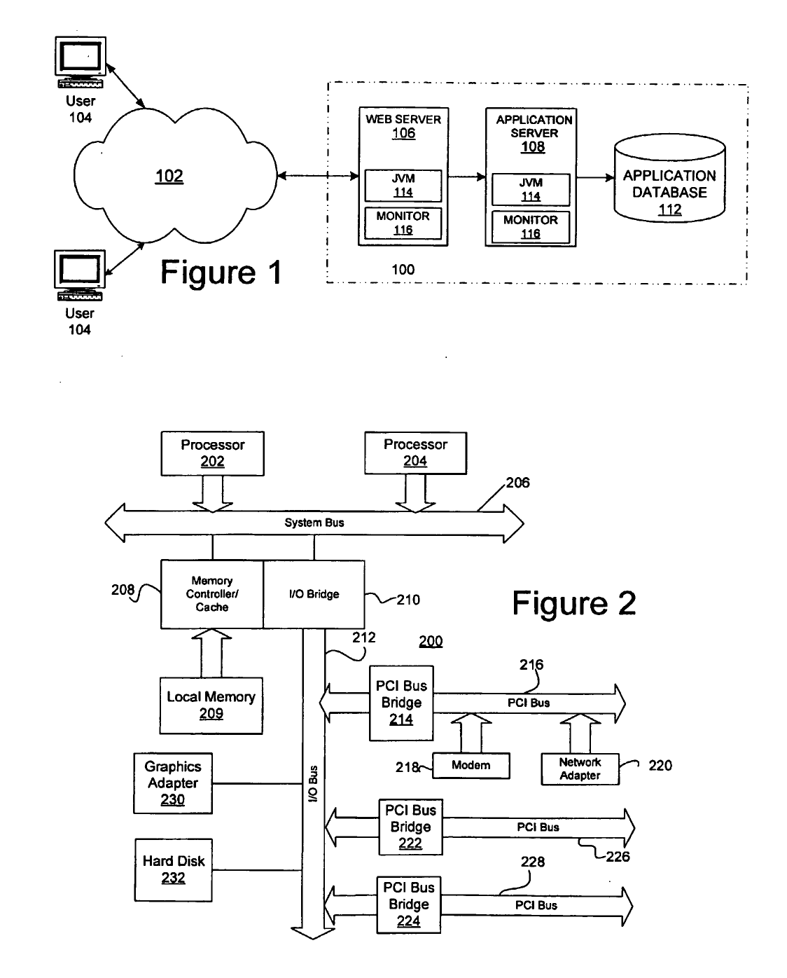

With reference to FIG. 1, a computer system 100 for a business entity is connected to the Internet 102 in order to provide computer services online. The website of the business entity is accessible to various online users 104.

In the presently preferred embodiment, Java 2 Platform Enterprise Edition (J2EE) is used on computer system 100. J2EE is a platform-independent, JAVA-centric environment from Sun Microsystems for developing, building and deploying Web-based enterprise applications online. The J2EE platform consists of a set of services, APIs, and protocols that provide the functionality for developing multitiered, Web-based applications. At the client level, J2EE supports pure HTML, as well as Java applets or applications. Enterprise JavaBeans (EJBs) provide another layer where the platform's logic is stored. Within computer system 100, Web server 106 is configured to communicate over the Internet, as well as within the intranet of system 100; application server 108 is only connected to communicate within the intranet, but can access application database 112. In addition to other programs and processes that exist on these servers, each of server 106, 108 contains a copy of Java Virtual Machine (JVM) 114 and monitoring program 116, which will be discussed further below. One of ordinary skill in the art will recognize that many other configurations are possible in the disclosed intranet. For example, the web server and the application server can be on a single machine. Conversely, there may be a number of both web servers and application servers; there may also be separate database servers if the situation required it.

Referring to FIG. 2, a block diagram of a data processing system that may be implemented as a server, such as servers 106, 108 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to users 104 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

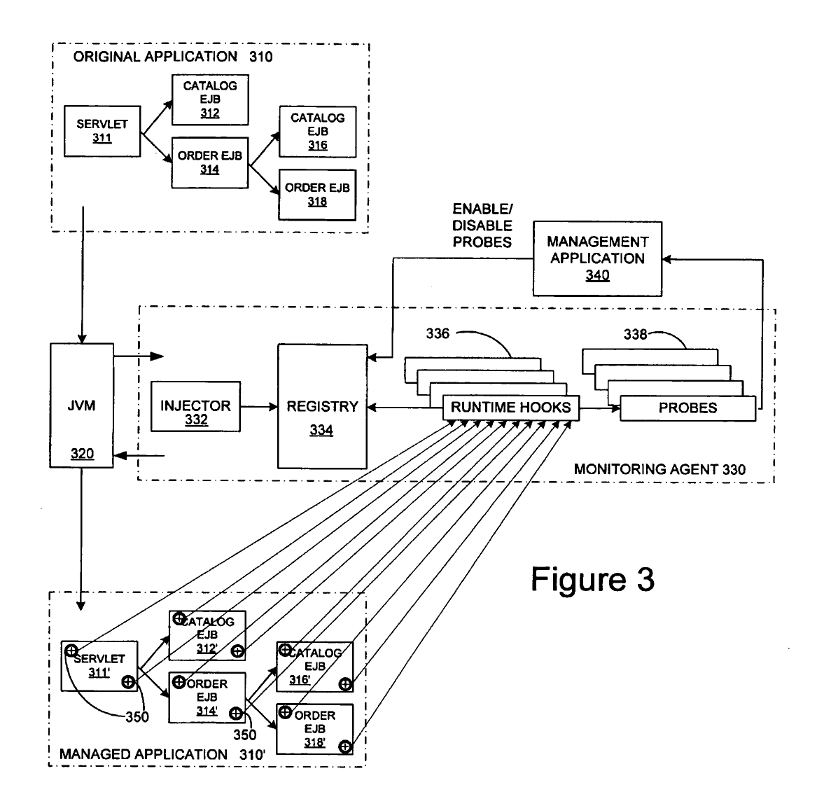

With reference to FIG. 3, an overview the relationship between an application 310, a copy of the Java Virtual Machine (JVM) 320, and a monitoring agent 330 is shown. A bi-directional interface exists between JVM 320 and monitoring agent 330. Monitoring agent 330 contains injector 332 (which injects byte codes or hooks into applications), registry 334 (which contains a registry of all enabled probes), hooks 336 (which contain the logic to manage the execution of probes), and probes 338. Probes can be enabled or disabled by management application 340. Exemplary application 310 contains servlet 311, which invokes Enterprise JavaBeans (EJBs) 312, 314. In turn EJB 314 invokes further EJBs 316, 318. When application 310 is compiled by the JVM, the interface between JVM 320 and monitoring agent 330 allows injector 332 to inject special byte codes 350 into the components 311, 312, 314, 316, 318 of application class 310 to form managed application 310′. Note that each of the components 311′, 312′, 314′, 316′, 318′ of managed application 310′ contains inserted byte codes 350. These byte codes 350 correspond to hooks 336; when managed application 310′ executes, hooks 336 will interface with registry 334 and cause the desired probes 338 to execute.

Whenever a decision is made to monitor a given application, entries in the registry will define what methods to instrument and which probes to use with any particular method. In at least some embodiments, the customer can also define new methods to instrument using an existing probe.

Probes 338 are application components or probes that run in the same process as the monitored component of the application (e.g., servlet, EJB, etc.). The probe defines pre- and post-enabled entry points accessible by the hook, as well as the special-case entry point postThrown. PostThrown differs from post in that postThrown is invoked if and only if the application component completes because the component threw a java.lang.Throwable. The inserted byte code 350 invokes the pre-enabled entry point prior to the entry point of the application-component-being-monitored. Immediately after the monitored application component has completed, the hook invokes the post- or postThrown-enabled entry point, depending on which is appropriate. The enabled entry point determines whether pre, post, or postThrown are invoked.

In an exemplary embodiment of the invention, when the managed application 310′ is executed, the inserted byte codes 350 (e.g., hook, 336) invokes an intermediate Java class that was written to minimize the amount of byte code. This intermediate class, in turn, invokes the pre-enabled entry point of the probe. Thus, the injected code provides the ability to add monitoring abilities to the application components at load time. An application can be designed, coded, and distributed without knowledge of or ability to provide monitoring, yet by means of the inserted hooks, a probe can be provided that will monitor the application.

Because a probe 338 is a component external to the application 310′ it is monitoring, the probe must generally be passed information about the application and the parameters that the application is using. This information is the “context” of the application. The context includes but is not limited to references to the instrumented class, the instrumented methods, the object instance of the instrumented class, and the parameters used to invoke the method, if applicable. These can be obtained in different ways depending upon the injected byte code 350. In an exemplary embodiment, a new member variable is added to the instrumented class at the class level so that it is visible by all object instances. During initialization of the class, some of the context is assembled and stored in this object. The remaining context is assembled and given to the probe when requested prior to execution of the body of the probe.

It should be noted that the division between the code in the hook and the code in the probe can vary. In other words, it is possible for all of the coding of the probe to be injected directly into the monitored application, although this is not generally desirable. It is also possible to inject a minimum of code into the monitored application, e.g., the invocation of a probe, with the body of the monitoring code existing in the probe. Likewise, because the hook can invoke several probes, necessary code can be placed into a single probe or broken into several probes without going outside the scope of this invention.

Although there can be times when a probe does not need a context, it should be obvious that most probes do require a context in order to provide monitoring. In the prior art, if a probe 338 having a context is executed, the hook must first build up the context for the probe prior to allowing the probe to execute.

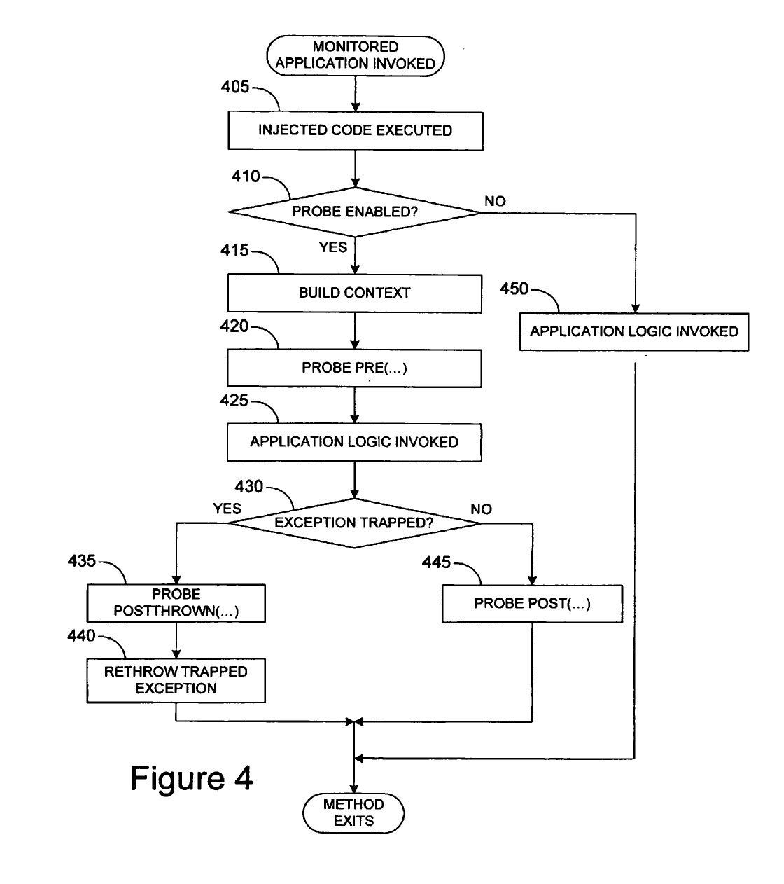

Turning now to FIG. 4, a flowchart is shown of the actions taken in a monitored application, according to an exemplary embodiment of the invention. The flowchart begins at the invocation of the application. Initially, the injected code is executed (step 405). As noted above, the injected code may perform the following steps or it may invoke one or more probes to execute these steps. In either case, an initial action is to determine if the probe is enabled (step 410), e.g., whether this specific transaction instance will be monitored, as decided by the management application 340. If the probe is enabled, the context for this application will be completed and made available (step 415). The preliminary steps of the monitoring probe are then executed (step 420). Once the initial monitoring steps are completed, the logic of the monitored application is invoked (step 425) and executed. Afterwards, a decision is made as to whether an exception was trapped (step 430). This determines whether the post or postThrown are executed. If an exception has been trapped, postThrown is executed (step 435) and the trapped exception rethrown (step 440); otherwise, post is executed (step 445). When post or postThrown are completed, the method exits. If it was determined at step 410 that the probe was not enabled and would not be monitored, the application logic is invoked (step 450) and the method exits without further monitoring attempts. Although it is possible to program this flow in a number of ways, in at least one embodiment of the invention, creation of the managed application in FIG. 3 actually results in a new method being defined for each monitored method in the application. For example, when servlet 311 passes through JVM 320, a new servlet 311′ is created that contains the monitoring logic and which invokes the monitored servlet 311, e.g. at steps 420 and 450 of FIG. 4.

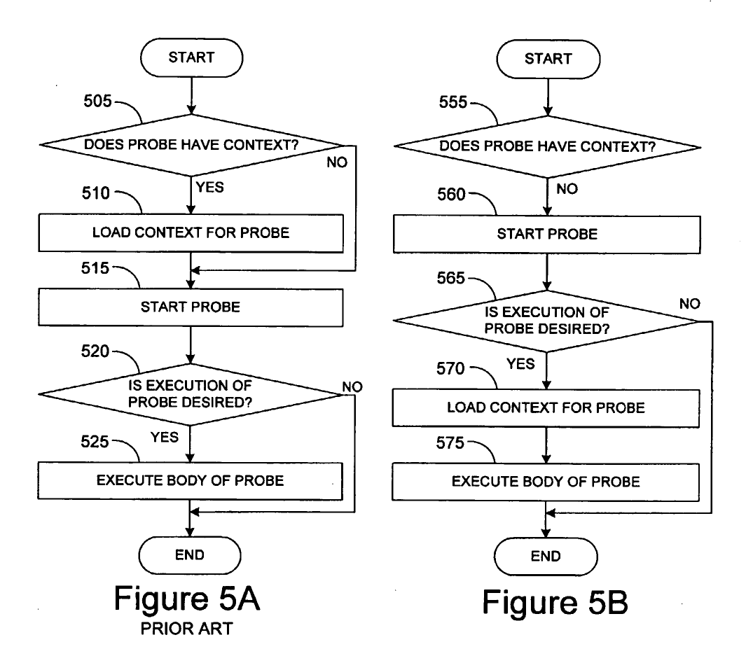

With reference now to FIGS. 5A and 5B comparative high-level flowcharts are shown for executing a probe according to the prior art and according to an embodiment of the invention. Both flowcharts start at the point where a hook has been triggered and starts the process for running the probe. In FIG. 5A, the hook checks to see if this probe has a context (step 505). If the probe has a context, the hook immediately loads the context information (step 510); otherwise the loading step is skipped. The probe is then started (step 515). Next, the probe must determine whether the system desires the probe to execute in its entirety (step 520), e.g., whether this specific instance of the monitored application is enabled for monitoring. This is determined by interfacing to management program 340. In an exemplary embodiment, the management program makes the decision to monitor a specific transaction, based on predetermined criteria, such as sampling rate, customer identification, etc. If execution of the probe is desired, the body of the probe will then be executed to perform monitoring (step 525); otherwise this step will be skipped. The process is then complete. In most monitoring systems, the sampling rate is less than 50%. Therefore, the overhead of building a context is wasted when the probe does not completely execute.

In FIG. 5B, the method for executing a probe according to an exemplary embodiment of the invention is disclosed. In this flowchart, the hook again checks to determine if the probe has a context (step 555). When the inventive process is used, this answer will always be “no”, because the enable module is defined as not having a context. This means that loading of any context for the main portion of the probe will be deferred until it is determined that the probe is enabled. The probe is then started, or more properly speaking, the enable module of the probe is started (step 560). The first job of the enable module is to determine whether the execution of the entire probe is desired (step 565). This can be determined in the same manner as in the prior art. For example, the enable module can look at the current thread ID, then use the thread ID to determine if there is a transaction model for this transaction. Such a transaction model is maintained by the management process 340, which manages monitoring. If there is no transaction model, there is no need to perform the body of the probe. If a transaction model does exist, this is an indication that the probe should be run in its entirety. Of course, this is not the only method of determining whether or not to enable the probe. Exemplary monitoring policies can include (a) transaction based component trace levels—e.g. a particular transaction would define the EJB trace level to be 0 or 1, 0 meaning do not fire the probe and 1 meaning fire the probe, (b) sampling rate—e.g. fire the probe 10% of the time using a random number generator, (c) privacy and security configurations—if the execution of the probe could cause a violation of privacy laws or expose secure data, the customer can configure to not fire probes where applicable.

If the system on which the innovative program is running uses resource models instead of transaction models, the enablement of a component can be determined in conjunction with a monitoring schedule, e.g. only monitor this component during business hours, etc.

If the probe is enabled, the enable module will load the context for the probe (step 570), a job previously performed by the hook, then cause the body of the probe to execute (step 575). If it is not necessary to run the rest of the probe, these further steps will be skipped and the overhead of loading the context is avoided. The flowchart then terminates.

Thus, a system and method for reducing the overhead required by a monitoring program has been disclosed. Rather than loading a context for a component and then determining whether the component will fully execute, the loading of the context is delayed until after it is determined that the component will execute.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the invention is not restricted to use with Java. It could also be used with other systems, such as Microsoft's Net, which use byte code and virtual machine in analogous ways. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of monitoring a transaction, comprising the computer-generated steps of:
invoking a first section of a probe for monitoring a transaction, wherein said first section has no context;
determining, through said first section of said probe, if said probe is enabled; and
if said probe is enabled, loading a context of a second section of said probe, executing said second section, and invoking the transaction; else exiting said first section and invoking the transaction without executing said second section.

2. The method of claim 1, further comprising the step of inserting a hook into a component of the transaction, wherein said hook invokes said probe.

3. The method of claim 2, wherein said hook is a byte code.

4. The method of claim 1, wherein said method is executing in a Java environment.

5. The method of claim 1, wherein said determining step interfaces with a program for managing monitoring of transactions.

6. The method of claim 1, wherein said probe is randomly enabled for a given percentage of inquiries.

7. The method of claim 1, wherein said context contains at least one of an instrumented class, instrumented methods, an object instance of said instrumented class, and parameters used to invoke said transaction.

8. A computer program product on a computer readable media, said computer program product comprising:
first instructions for invoking a first section of a probe for monitoring a transaction, wherein no context is loaded for said first section;
second instructions for determining, through said first section of said probe, if said probe is enabled;
third instructions for loading a context of a second section of said probe and executing said second section if said probe is enabled; and
fourth instructions for exiting said first section and not executing said second section if said probe is not enabled.

9. The computer program product of claim 8, further comprising fifth instructions for inserting a hook into a component of the transaction, wherein said hook invokes said probe.

10. The computer program product of claim 9, wherein said hook is a byte code.

11. The computer program product of claim 8, wherein said instructions are executing in a Java environment.

12. The computer program product of claim 8, wherein said second instructions interface with a management program to determine if said probe is enabled.

13. The computer program product of claim 8, wherein said probe can be entered from an entry point chosen from the group consisting of pre, post, and postThrown entry points.

14. A computer system, comprising:
a plurality of servers that are connected to the Internet to interface with clients and connected to a database to provide information;
a plurality of transactions running on said plurality of servers, said transactions being the means by which the information is supplied to the clients;
a monitoring program connected to monitor said plurality of transactions, wherein said monitoring program contains
first instructions for invoking a first section of a probe for monitoring a transaction, wherein no context is loaded for said first section;
second instructions for determining, through said first section of said probe, if said probe is enabled;
third instructions for loading the context of a second section of said probe and executing said second section if said probe is enabled; and
fourth instructions for exiting said first section and not executing said second section if said probe is not enabled.

15. The computer system of claim 14, wherein said probe is invoked by inserted byte code injected into a component of the transaction.

16. The computer system of claim 14, wherein said monitoring program is a Java program.

17. The computer system of claim 14, wherein said first instructions interface with a management program to determine if said probe is enabled.

18. The computer system of claim 14, wherein said probe can be entered at a point chosen from the group consisting of pre, post, and postThrown entry points.

19. The computer system of claim 14, wherein a determination of enablement of said probe is made on a transaction-by-transaction basis.

20. The computer system of claim 14, wherein said probe is enabled if it contains a transaction model.
